(19) United States
(12) Patent Application Publication
(10) Pub. No.: US 2009/0241772 A1
(43) Pub. Date: Oct. 1, 2009

(54) Particle Separator for Separating Drill Cuttings From an Air Flow and a Drill Rig as Well as a Method for Controlling a Particle Separator

(76) Inventor: Jonas Stenstrom, Kumla (SE)

Correspondence Address: Mark P. Stone;Attorney at Law, 50 Broadway, Hawthorne, NY, 10532, US

(21) Appl. No.: 12/085,737

(22) PCT Filed: Oct. 20, 2006
(86) PCT No.: PCT/SE2006/050415

§ 371 Date: May 29, 2008

(30) Foreign Application Priority Data
Dec. 21, 2005 (SE) 0502831-1

(51) Int. Cl. B01D 46/46; B01D 50/00

(52) U.S. Cl. 95/23; 96/405; 96/400

(57) ABSTRACT

The invention relates to a particle separator for separating drill cuttings from an air flow, including a main separator (15) that comprises an air inlet (17) connectable to a suction nozzle, an air filter (19) arranged downstreams of said air inlet (17) and an air outlet (18) arranged downstreams of said air filter (19), the particle separator comprising means for generating an air flow, in the direction from said air inlet (17) to said air outlet (18). The particle separator also comprises means (41) for measuring a quantity of said air flow, and means for controlling the air flow generating means based on the measured quantity. The invention also relates to a drill rig comprising such a particle separator and a method for controlling such a particle separator.

### TECHNICAL FIELD OF THE INVENTION

The present invention relates generally to the field of separation of particle from an air flow, and more specifically to a particle separator for separating drill cuttings from an air flow. The present invention also relates to a drill rig comprising such an particle separator, as well as a method for controlling such an particle separator.

Said particle separator includes a particle separator for separating drill cuttings from an air flow, including a main separator that comprises an air inlet connectable to a suction nozzle, an air filter arranged downstreams of said air inlet and an air outlet arranged downstreams of said air filter, the particle separator comprising means for generating an air flow, in the direction from said air inlet to said air outlet.

The invention is applicable to all kinds of constructions/vehicles equipped with a particle separator. However, a preferred application is for drill rigs, in particular mobile drill rigs for drilling in rock and above all drill rigs for drilling in rock above ground.

### BACKGROUND OF THE INVENTION

The background of the invention is a problem concerning short life cycles of air filters comprised in particle separators, as well as superfluously hard wear on other components of the particle separators, as well as hoses, suction nozzle, etc.

In known particle separators (also known as dust separator, dust collecting equipment, or the like) the rotational speed of the fan is fixed and chosen high enough for the air flow speed to be sufficient during all stages of the entire life cycle of the air filter, even though the air filter is getting more and more clogged. In the beginning of the life cycle of the air filter, the air flow speed is extremely high due to the fact that the air filter is clean and thereby presents a lower air resistance. However, due to the higher air flow speed the dust/particles penetrates deeper into the air filter upon impact, which result in that the air filter gets clogged and worn out faster. Besides that a high rotational speed of the fan causes more intense wear on other components as well.

### SUMMARY OF THE INVENTION

The present invention aims at obviating the aforementioned disadvantages of previously known particle separators, and at providing an improved particle separator. A primary object of the present invention is to provide an improved particle separator of the initially defined type, the components of which having longer life cycles due to controlled air flow speed and thereby less damages during operation. It is another object of the present invention to provide a particle separator having a more efficient and better separation due to controlled air flow speed throughout the entire life cycle of the air filter. It is yet another object of the present invention to provide a particle separator having a lower fan capacity, and thereby a lower power consumption.

According to the invention at least the primary object is attained by means of the initially defined particle separator having the features defined in the independent claim 1. More precisely, there is provided a particle separator of the initially defined type, which is characterized in that the particle separator comprises means for measuring a quantity of said air flow, and means for controlling the air flow generating means based on the measured quantity.

Thus, the present invention is based on the insight of the importance that a controlled air flow speed during the entire life cycle of the air filter, result in a longer life cycle of the air filter and other components.

Preferred embodiments of the present invention are further defined in the dependent claims.

In a preferred embodiment of the present invention, the measuring means is arranged upstreams of the air filter and the quantity of the air flow is air pressure. A predetermined underpressure on the upstream side of the air filter may be obtained, and thereby a more adapted environment is established for the air filter in particular and the other components in general.

In a preferred embodiment of the present invention, the particle separator also comprises a preseparator located upstreams of the main separator, e.g. for separating larger particles from the air flow. As a consequence of a lower air flow speed a better and more efficient separation of particles is carried out in said preseparator. In known particle separators usually even medium sized particles followed the air flow through said preseparator, which now can be separated therein.

According to the present invention, there is also provided a drill rig according to claim 14 and a method according to claim 15.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a perspective view from above of a drill rig, comprising a particle separator according to the invention,

FIG. 2 is a semi cutaway perspective view from above of a main separator, comprised in a particle separator according to the invention, and

FIG. 3 is a cutaway perspective view from above of a preseparator, comprised in a particle separator according to the invention.

### DETAILED DESCRIPTION OF PREFERRED EMBODIMENTS OF THE INVENTION

It shall be pointed out that the invention is applicable on all kinds of vehicles, constructions and arrangements, having a particle separator for dust and particle separation/collection. Thereto the term particle separator, as used in the claims as well as in the detailed description, includes different types of devices arranged to separate dust and particles from a created air flow. Said devices may be called and includes dust separators, dust collecting equipment, vacuum cleaners, and the like. The invention will be described below arranged in a mobile drill rig. This is to be regarded only as an example of a preferred application, and not as a limitation.

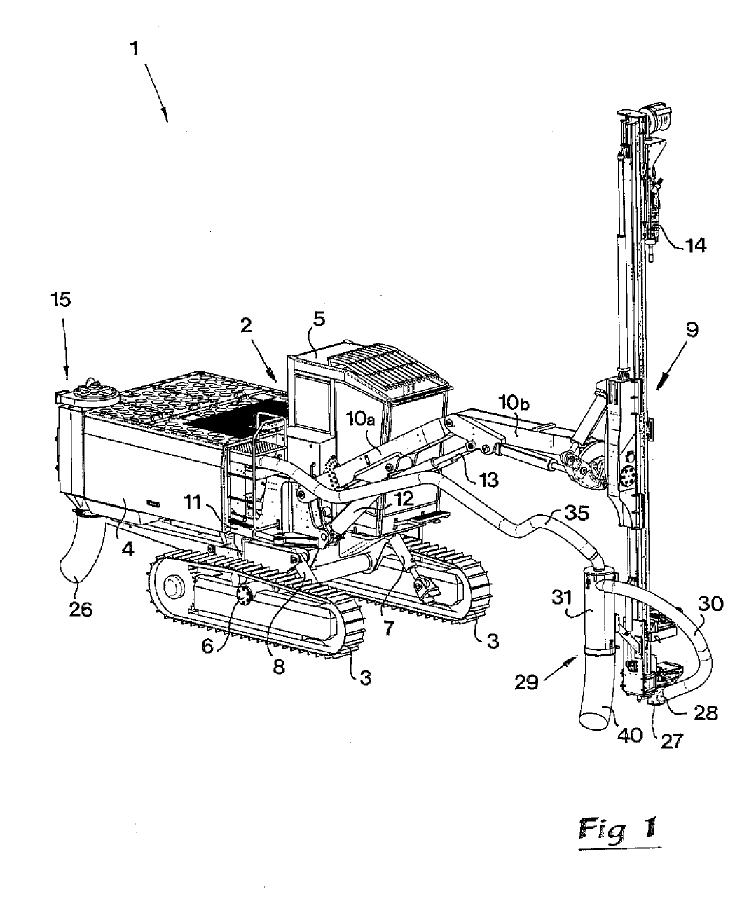

In FIG. 1 is shown a perspective view of a drill rig, generally designated 1. Said drill rig 1 comprises a vehicle body 2 carried by a pair of caterpillars 3, ground engagement elements, wheels or the like. The vehicle body 2 comprises a chassis 4 forming an engine compartment, located in the rear part of the vehicle body 2, and a cab 5 for an operator who controls the drill rig 1, located in the front part of the vehicle body 2. The vehicle body 2 is tiltable around a shaft 6 in relation to the caterpillars 3, or vice versa, by means of a pair of actuators, preferably in the shape of hydraulic cylinders 7, 8. It shall be pointed out that said hydraulic cylinders 7, 8 may be extended and/or contracted independently of each other, for instance when the drill rig 1 is operated on very rough ground and the caterpillars 3 needs to be directed in different angles in relation to the vehicle body 2.

Further, the drill rig 1 comprises an equipment 9, or a feeder, which is carried by a bar arrangement, including one or more bars 10a, 10b. Said bar arrangement is connected to the vehicle body 2 in the front part thereof, the bar arrangement being turnable in a horizontal direction in relation to the vehicle body 2, by means of an actuator 11. Furthermore, a first bar 10a may be turned in a vertical direction by means of an actuator 12. Thereto a second bar 10b may be turned in a vertical direction in relation to said first bar 10a, by means of actuators 13. In the front end of the second bar 10b is said feeder 9 provided, comprising a drilling equipment 14, which feeder 9 is turnable in relation to the second bar 10b, from side to side as well as forwards and backwards. Thus, the radius of working and the accessibility of the drill rig 1 is determined by the bar arrangement and the feeder 9, which are of conventional type.

Before drilling takes place, the feeder 9 is lowered until the lower end thereof is adjacent to the ground. In order to form a drill hole, a cutter head (not shown) is rotated whilst being in engaged with the ground, either by using percussion drilling or by drilling using constant contact pressure. The cutter head is located at a free lower end of a drill pipe (not shown), which is operated by means of the drilling equipment 14. The lower end of the feeder 9 guides the drill pipe during operation. The cutter head may for instance be driven hydraulically, pneumatically, mechanically, etc. During drilling, drill cuttings are generated down the drill hole, which needs to be removed in order not to obstruct continued drilling. The drill cuttings are flushed out of the drill hole, e.g. be means of a flush fluid entering the drill hole at the cutter head. A particle separator, e.g. according to the invention, may then be used in order to remove the drill cuttings from the orifice of the drill hole.

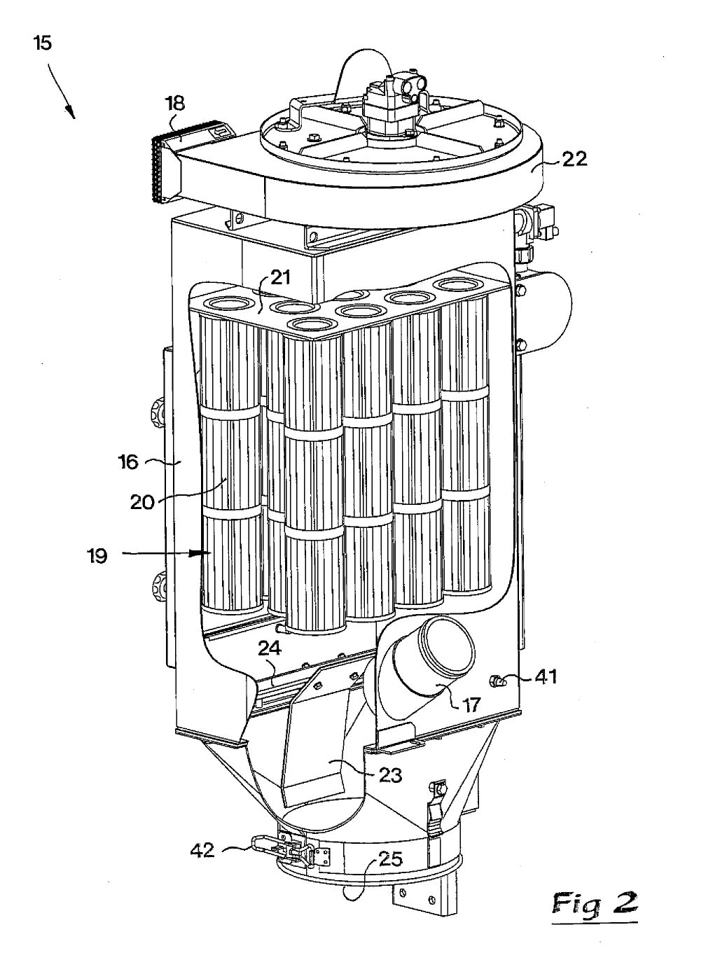

Reference is now also made to FIG. 2. A particle separator according to the invention comprises a main separator, generally designated 15, which is connected to the drill rig 1. In the shown embodiment the main separator 15 is located at the rear part of the vehicle body 2 of the drill rig 1 (see FIG. 1). However, the main separator 15 may be located at any suitable location on the drill rig 1, e.g. at the front part of the vehicle body 2 of the drill rig 1, or under the chassis 4 of the vehicle body 2. Said main separator 15, comprises a housing 16, also known as a filter housing, having an air inlet 17 and an air outlet 18. Said housing 16 is divided into an inlet compartment and an outlet compartment, by means of an air filter 19. The air filter 19 is arranged downstreams of the air inlet 17 and upstreams of the air outlet 18. In the shown embodiment said air filter 19 comprises several filter element 20 connected to a partition plate 21. In the shown embodiment each filter element 20 is constituted by a tubular shaped element, one end of which being attached to a corresponding hole of said partition plate 21 and the other end of which being closed. Air is admitted to penetrate through the tube wall of the filter element 20, from the inlet compartment into the interior of the filter element 20 an onwards through said hole of the partition plate 21 to the outlet compartment. It shall be pointed out that said filter 19 may be of any shape and size suitable for the individual application, e.g. a flat filter element dividing the inlet compartment from the outlet compartment.

Furthermore, the particle separator comprises means for generating an air flow from the air inlet 17 to the air outlet 18 of said main separator 15. Preferably said means is constituted by a fan or the like (not shown) arranged in a fan housing 22 comprised in the main separator 15. Preferably, the fan is arranged downstreams of the filter 19 and upstreams of the air outlet 18, as seen in a direction of the air flow during operation. Furthermore, the fan may be reversible, or a separate compressed air device is provided, in order to clean the filter elements 20 by applying a short or long reversed air pulse or air flow through the filter 19. Said means may also be constituted by an ejector, which by means of a flow of compressed air in a suitable direction generates, by the jet effect, an air flow from the air inlet 17 towards the air outlet 18. It shall be pointed out that other suitable means for generating an air flow is included.

In a preferred embodiment the air inlet 17 is not directed towards the filter 19, instead the air flow is directed towards a plate 23, or baffle, in order to let the particles, solids, drill cuttings, and the like, comprised in the air flow hit said plate 23. Upon impact the particles looses kinetic energy and will fall downwards away from the filter 19. Said plate may be arranged adjacent to an, in relation to the air inlet 17, opposite wall of the house 16, or may be arranged closer to the air inlet 17 by being connected to a crossbeam 24 or the like.

Furthermore, the particle separator 15 present a particle outlet 25 and an element 26 for closing said particle outlet 25 when the air flow generating means is active, and opening said particle outlet 25 when the air flow generating mean is deactivated. Said element 26 may be a lid, a cover, or a flexible tube as in the shown embodiment (see FIG. 1). For a better understanding, said flexible tube 26 may be compared with a part of an inner tube of a tractor tyre. Said flexible tube 26 may be applied on the particle outlet 25, and secured by means of a tube clamp, an eccentric lock, or the like 42. Upon activation of the air flow generating means, said flexible tube 26 will collapse due to the caused underpressure in the inlet compartment, and thereby close the particle outlet 25.

The air inlet 17 of the main separator 15 is connectable to a suction nozzle 27, also known as a suction hood (see FIG. 1). Upon drilling, said suction nozzle 27 is located at the orifice (not shown) of the drill hole. The suction nozzle 27 is connected to the lower end of the feeder 9, and is arranged to seal between the drill hole and the drill pipe in such a way that no drill cuttings may pass out into the open air. The suction nozzle 27 comprises an outlet 28 to which the air inlet 17 of the particle separator 15 is connected by means of a hose, or the like, in order to suck the drill cuttings from the orifice of the drill hole. When an air flow is generated the drill cuttings will be sucked to the main separator 15, and there they will hit the plate 23 and be accumulated in the lower part of the housing 16. Upon deactivation of the air flow generating means the underpressure in the inlet compartment will cease, and as a consequence the flexible hose 26 will open and let the accumulated particles out.

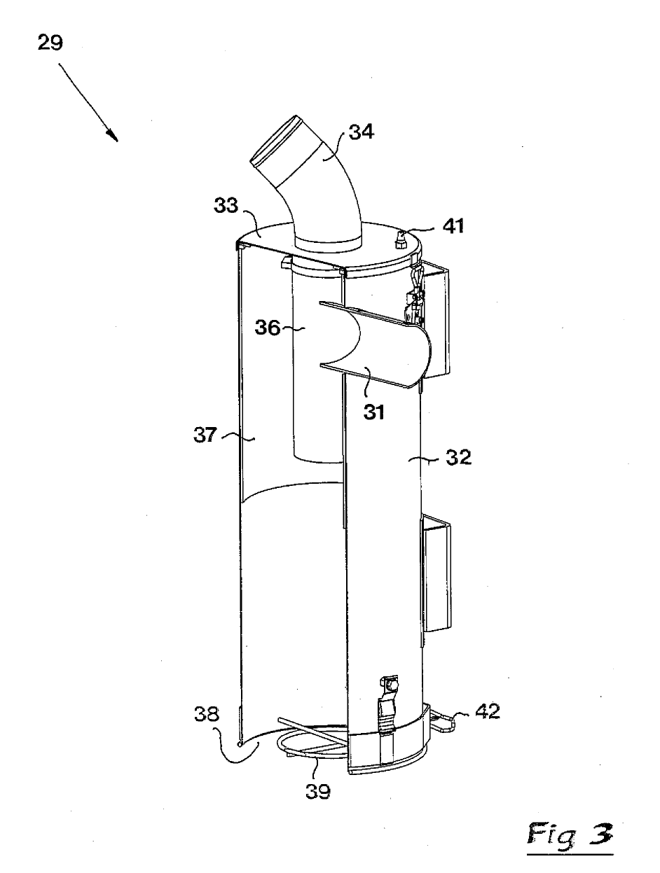

Reference is now also made to FIG. 3. In a preferred embodiment of the present invention there is arranged an intermediate preseparator 29 between the main separator 15 and the suction nozzle 27. Preferably said preseparator 29 is arranged close to the suction nozzle 27 and a hose 30, or conduit, extends from the outlet 28 of the suction nozzle 27 towards the preseparator 29, more precisely towards and connected to an air inlet 31 of said preseparator 29. In the shown embodiment the preseparator 29 is connected to the feeder 9. It shall be pointed out that the preseparator 29 is optional.

The main purpose of the preseparator 29 is to separate particles from the air flow at an early stage sparing other components located further downstreams, and above all to separate large particles from the air flow. The preseparator 29 comprises a main body 32, said main body 32 having a generally tubular shape in the shown embodiment. A first upper end of the main body 32 is closed by a lid 33, from the lid 33 outwards extends an air outlet 34 of the preseparator 29. It shall be pointed out that the lid 33 may be integral with the main body 32 of the preseparator 29. Said air outlet 34 of the preseparator 29 is connected to the air inlet 17 of the main separator 15 by means of a hose 35, a conduit or the like. The air outlet 34 is preferably concentric to the lid 33 and to the main body 32 of the preseparator 29, even though the air outlet 34 may be arranged in any other suitable way. From the lid 33 inwards extends an outlet pipe 36, terminating inside the main body 32. The air inlet 31 of the preseparator 29 is located eccentric to a centreline of the main body 32 of the preseparator 29, and eccentric to said outlet pipe 36. Preferably the air inlet 31 is located closer to the lid 33 than a free end of said outlet pipe 36. The preseparator 29 works as a cyclone, the particles being slung against the inside of the main body 32 and thereby loosing their kinetic energy, or speed. Next the particles will drop downwards in the main body 32 of the preseparator 29, and the air flow proceeds in a spiral shaped flow downwards until it is sucked into said outlet pipe 36.

On the inside of the main body 32 close to the first upper end thereof, more precisely, at the level of the air inlet 31, a reinforcement 37 is preferably provided in order to strengthen the resistance against the impact of the incoming particles. A second lower end of the main body 32 comprises a particle outlet 38, which is provided with a grid 39, or the like. An element 40 (see FIG. 1) is connectable to the second lower end of the main body 32. The function of said element 40 is to close said particle outlet 38 of the second lower end of the main body 32 when the air flow generating means is active, and open said particle outlet 38 when the air flow generating means is deactivated. Everything described above in connection with the element 26 of the main separator 15 is applicable on said element 40 of the preseparator 29. It shall also be pointed out that the particle outlet 25 of the main separator 15 is provided with a grid as the one provided in the particle outlet 38 of the preseparator 29. The purpose of the grids is to prevent the flexible hoses 26, 40 from being sucked into the housing 16 and the main body 32, respectively, during operation of the air flow generating means.

The particle separator also comprises means 41 for measuring a quantity of the air flow. Preferably said measuring means 41 is a sensor, for measuring the air pressure, the air flow speed, or any other suitable quantity of the air flow. In a preferred embodiment, the sensor 41 is located upstreams of the air filter 19, more precisely in the inlet compartment of the main separator 15. The sensor 41 should be located in such a way that it is protected from a direct hit of the air flow. If the sensor 41 is placed in line with the air inlet 17 the sensor 41 may get damaged by the incoming particles and make a false measuring of the quantity. Therefore a location situated next to the air inlet 17 is preferred. It shall be pointed out that the sensor 41 alternatively can be arranged in the pre-separator 29 and in that case preferably in the lid 33 next to the outlet pipe 36.

The main purpose of the sensor 41 is to give an indication about the air speed and how strained the air filter 19 is. For instance, a really high underpressure, or a really low pressure, in the inlet compartment is an indication of a high air flow speed. If the air flow speed is high, the kinetic energy of the particles is high as well. Then the risk of damaging the air filter 19 or other components of the particle separator, such as the hoses 30, 35 connecting the suction nozzle 27, the preseparator 29 and the main separator 15, as well as the preseparator 29 and the main separator 15, is high. Thereto, a poor particle separation is performed in the pre-separator 29, since the suspension force from the air flow on the particles is higher than the gravitation. Furthermore, an almost immeasurable underpressure in the inlet compartment is an indication of a low air flow speed. If the air flow speed is low even though the rotational speed of the fan is high, the air filter 19 is in all probability severely clogged and needs to be replaced.

Furthermore the particle separator also comprises means for controlling the air flow generating means based on the measured quantity. Preferably said controlling means is a control unit (not shown), such as a CPU, the control unit being either a separate one for the particle separator or a one already existing in the drill rig 1. The control unit may be programmable and comprise a plurality of inputs and outputs for signal transfer. The sensor (41) is operatively connected to the control unit, preferably by means of cabling or wireless communication. The function of the control unit is to control and adjust the output of the air flow generating means in order to reach a predetermined level of the measured quantity of the air flow. For instance, if the underpressure in the inlet compartment of the main separator 15 is above the predetermined value, then the sensor 41 transmit a signal corresponding to the measured value to the control unit, which determines that the output of the fan should be reduced, and vice versa. The signal from the sensor 41 may be transmitted either continuous or at regular intervals.

### FEASIBLE MODIFICATIONS OF THE INVENTION

The invention is not limited only to the embodiments described above and shown in the drawings. Thus, the particle separator may be modified in all kinds of ways within the scope of the appended claims.

It shall be pointed out that if the fan, or air flow gene-rating means, is driven hydraulically, pneumatically, or the like, the measuring means may be a bellow or diaphragm located in the main separator, which mechanically affects a valve, or controlling means, effecting the inflow of oil or air to the fan, and thereby controlling the output of the fan. In other word, the function of controlling the air flow generating means may be completely mechanical.

It shall also be pointed out that all information about/concerning the terms upper, lower, etc., should be interpreted/read having the devices in their normal working orientation as they are displayed in the drawings having the drawings oriented in such a way that the reference signs could be properly read.

1. A drill cuttings separator for separating drill cuttings from an air flow, including a main separator (15) that comprises an air inlet (17) connectable to a suction nozzle (27), an air filter (19) arranged downstreams of said air inlet (17) and an air outlet (18) arranged downstreams of said air filter (19), the drill cuttings separator comprising means for generating an air flow, in the direction from said air inlet (17) to said air outlet (18), characterized in that the drill cuttings separator comprises means (41) for measuring a quantity of said air flow in order to obtain an indication about how strain said air filter (19) is, and means for controlling the air flow generating means based on the measured quantity.

2. A drill cuttings separator according to claim 1, wherein said quantity of the air flow is air pressure.

3. A drill cuttings separator according to claim 1, wherein said quantity of the air flow is air flow speed.

4. A drill cuttings separator according to claim 1, wherein said measuring means (41) is arranged upstreams of the air filter.

5. A drill cuttings separator according to claim 1, wherein said measuring means (41) is arranged in the main separator (15).

6. A drill cuttings separator according to claim 1, wherein the air flow generating means is arranged downstreams of the filter.

7. A drill cuttings separator according to claim 6, wherein said air flow generating means is a fan.

8. A drill cuttings separator according to claim 1, wherein said measuring means (41) is a sensor.

9. A drill cuttings separator according to claim 1, wherein said controlling means is a control unit.

10. A drill cuttings separator according to claim 1, wherein the main separator (15) comprises a particle outlet (25), and an element (26) arranged thereto, for closing said particle outlet (25) when the air flow generating means is active and opening said particle outlet (25) when the air flow generating means is deactivated.

11. A drill cuttings separator according to claim 1, wherein the drill cuttings separator comprises a preseparator (29) located upstreams of the main separator (15), and downstreams of the suction nozzle (27).

12. A drill cuttings separator according to claim 11, wherein the preseparator (29) is a cyclone, having an air inlet (31) connectable to said suction nozzle (27) and an air outlet (34) connectable to the air inlet (17) of the main separator (15).

13. A drill cuttings separator according to claim 11, wherein the preseparator (29) comprises a particle outlet (39), and an element (40) arranged thereto, for closing said particle outlet. (39) when the air flow generating means is active and opening said particle outlet (39) when the air flow generating means is deactivated.

14. A drill rig, characterized in that it comprises a drill cuttings separator according to claim 1.

15. A method for controlling a drill cuttings separator comprising a main separator (15) that comprises an air inlet (17) connectable to a suction nozzle (27), an air filter (19) arranged downstreams of said air inlet (17) and an air outlet (18) arranged downstreams of said air filter (19), the drill cuttings separator comprising means for generating an air flow, in the direction from said air inlet (17) to said air outlet (18), said method comprising the steps of:
measuring a quantity of said air flow in order to obtain an indication about how strained said air filter (19) is, and
controlling said air flow generating means based on the measured quantity.

16. A drill cuttings separator according to claim 2, wherein said measuring means (41) is arranged upstreams of the air filter.

17. A drill cuttings separator according to claim 2, wherein said measuring means (41) is arranged in the main separator (15).

18. A drill cuttings separator according to claim 2, wherein the air flow generating means is arranged downstreams of the filter.

19. A drill cuttings separator according to claim 2, wherein said measuring means (41) is a sensor.

20. A drill cuttings separator according to claim 12, wherein the preseparator (29) comprises a particle outlet (39), and an element (40) arranged thereto, for closing said particle outlet (39) when the air flow generating means is active and opening said particle outlet (39) when the air flow generating means is deactivated.
